(19) United States
(12) Patent Application Publication
(10) Pub. No.: US 2022/0289233 A1
(43) Pub. Date: Sep. 15, 2022

(54) TRACE GRAPH AS A SURROGATE FOR OPERATING/DRIVING SCENARIOS

(71) Applicant: Robert Bosch GmbH, Stuttgart (DE)

(72) Inventors: Antonia Reiter, Stuttgart (DE); Indrasen Raghupatruni, Hemmingen (DE); Maria Belen Bescos Del Castillo, Moensheim (DE); Marius Knepper, Mainz (DE)

(21) Appl. No.: 17/685,562

(22) Filed: Mar. 3, 2022

(30) Foreign Application Priority Data
Mar. 10, 2021 (DE) 10 2021 202 333.9

(51) Int. Cl. B60W 60/00; G07C 5/08; G07C 5/00; G08G 1/00

(52) U.S. Cl. CPC B60W 60/001; G07C 5/0841; G07C 5/008; G08G 1/20; B60W 2554/4049; B60W 2554/4041

(57) ABSTRACT

A computer-implemented method for generating an operating scenario of a vehicle based on a trace graph. The method includes obtaining the trace graph, selecting a trace in the trace graph, and reconstructing an operating scenario of a vehicle from the trace of the trace graph. A computer-implemented method for generating a trace graph for one or multiple time recordings of an operating scenario of a vehicle is also provided, including clustering y values of the one or multiple time recordings into at least two clusters in a space whose dimensionality corresponds to the number of the one or multiple time recordings, optionally with the aid of unsupervised learning, identifying at least one cluster as a node in the trace graph, analyzing the transitions between clusters, based on the one or multiple time recordings, and identifying at least one transition as an edge between two nodes in the trace graph.

### BACKGROUND INFORMATION

Operating and/or driving scenarios may represent important elements in the design and development of vehicles, in particular at least semi-autonomously operating vehicles. On the one hand, operating/driving scenarios may be measured during test operation and/or in ongoing operation of the vehicle fleet (i.e., as field data), and on the other hand, operating/driving scenarios may be simulated with regard to different details. One advantage of simulations of operating/driving scenarios may be that configurations/parameters (for example, lanes of the roadway, road users, the host vehicle trajectory, etc.) may be adjusted/varied in a targeted manner and efficiently tested virtually. In contrast, actual vehicle measurements (beyond software input values, for example) are generally less advantageously limited to certain configurations/parameters. In turn, actual vehicle measurements may be more reliable and realistic compared to the simulations. In recent years, simulation environments such as CARLA or CarMaker have been developed which may be used for developing, training, and/or validating at least semi-autonomous driving systems in order to simulate operating/driving scenarios as closely as possible to reality. Operating/driving scenarios may be used, for example, to define corner cases. In the context of at least semi-autonomous driving, operating/driving scenarios may be utilized in particular for developing and enhancing functionality and safety of the vehicle and its surroundings. For this purpose, the training data set of machine learning algorithms (for computer vision, for example) may be expanded and thus improved, for example via the operating/driving scenarios.

Operating/driving scenarios may be described by one or multiple time recordings, for example. Regardless of how they are created, such time recordings may have redundancy and/or may be associated with large data volumes. The memory requirements may be reduced by compression of operating/driving scenarios with the aid of an autoencoder, for example. Conventional compressions are universal, and may be applied to arbitrary data. In particular, they are not aimed at representability or interpretability of the operating/driving scenarios.

An autoencoder is an artificial neural network that is designed and trained (in unsupervised learning) for efficiently encoding data in an intermediate representation, the intermediate representation having a reduced dimensionality compared to the input and output of the artificial neural network. The computation of the intermediate representation from the input may be referred to as an encoder step, and the computation of the output from the intermediate representation may be referred to as a decoder step.

### SUMMARY

A first general aspect of the present disclosure relates to a computer-implemented method for generating an operating scenario of a vehicle based on a trace graph, including obtaining the trace graph, selecting a trace in the trace graph, and reconstructing an operating scenario of a vehicle from the trace of the trace graph.

A second general aspect of the present disclosure relates to a computer-implemented method for generating a trace graph for one or multiple time recordings of an operating scenario of a vehicle, including clustering of y values of the one or multiple time recordings into at least two clusters in a space whose dimensionality corresponds to the number of the one or multiple time recordings, optionally with the aid of unsupervised learning, identifying at least one cluster (a higher-dimensional value range, for example) as a node in the trace graph, analyzing the transitions between clusters, based on the one or multiple time recordings, and identifying at least one transition as an edge between two nodes in the trace graph.

A third general aspect of the present disclosure relates to a computer program that is designed to carry out the computer-implemented method according to the first general aspect (or a specific embodiment thereof) for generating an operating scenario based on a trace graph, and/or to carry out the computer-implemented method according to the second general aspect (or a specific embodiment thereof) for generating a trace graph for one or multiple time recordings.

A fourth general aspect of the present disclosure relates to a computer-readable medium or signal that stores and/or contains the computer program according to the third general aspect.

A fifth general aspect of the present disclosure relates to a computer system that is designed to execute the computer program according to the third general aspect.

The methods and systems provided in accordance with the present invention are directed on the one hand to the generation of an operating scenario based on a trace graph, and on the other hand to the generation of a trace graph for one or multiple time recordings of an operating scenario. A trace graph may thus be regarded as an aggregated and compressed form of memory, and in particular as a surrogate of an operating scenario, it being possible to (in turn) (re)construct an operating scenario from the trace graph.

Analogously to a conventional autoencoder from the related art, the generation of a trace graph for one or multiple time recordings of an operating scenario may be regarded as an encoder step, and the generation of an operating scenario based on the trace graph may be regarded as a decoder step. The trace graph thus corresponds to an intermediate layer in an artificial neural network of an autoencoder, the artificial neural network being designed and having been appropriately trained to initially map the input (in the present case, the operating scenario) onto the intermediate layer, in particular in a lower-dimensional and more abstract form, and then to map the intermediate layer onto an output that is structurally the same as the input and that reproduces the operating scenario. In contrast to the intermediate layer of the autoencoder, the trace graph may be represented in a two-dimensional plane, for example, and may be more easily interpreted by humans. Likewise in contrast to the intermediate layer of the autoencoder, the trace graph may also be more easily interpreted by a machine. Due to the interpretability, a trace graph may be modified in a targeted manner in order to obtain a certain operating/driving scenario in the decoder step. Such a procedure may be utilized, for example, to generate corner cases. In addition, it may be advantageous to compare, instead of operating/driving scenarios, their associated trace graphs. Such trace graph comparisons may be used, for example, to check whether an operating/driving scenario may be assessed as a new one compared to operating/driving scenarios that are already present. This may be efficient, since the existing operating/driving scenarios are in each case already stored as a trace graph, and it is not necessary to first simulate time recordings for the operating/driving scenarios.

Measured data (sensor data) that are detected during the operation and/or during the travel of a vehicle, in particular a vehicle for (semi-)autonomous driving, are an important input in the design and testing of the vehicle that accompany development and/or production in order to ensure reliable and safe operation of the vehicle. The measured data typically represent one, several (for example, more than 1, more than 2, more than 3, more than 4, more than 5, more than 10, or more than 20), or many (for example, more than 50, more than 100, more than 200, more than 500, or more than 1000) time recordings (for example, of vehicle speed, steering angle, sensor data of an imaging system, position data, etc.) over a certain time period. The time period may extend from a few interrupts (for example, more than two, more than five, more than ten, or more than one hundred) of a control unit (with 100 Hz clocking, for example) over more than one or multiple seconds, up to more than one or multiple minutes and/or more than one or multiple hours (in some examples, the time period may extend between 10 ms and one hour).

Such time recordings (in field data, for example) are often collected during operation of one, several (for example, more than 1, more than 2, more than 3, more than 4, more than 5, more than 10, or more than 20), or many (for example, more than 50, more than 1e2, more than 1e3, more than 1e4, more than 1e5, more than 1e6, or more than 1e7) vehicles. However, as a function of the data density in the time recordings and depending on the fleet size, very large data volumes typically result which take up considerable memory space (on a cloud server, for example). Alternatively or additionally, the evaluation of such a data volume may require a large amount of computing time. In particular in cases in which the time recordings are collected not only in test phases during development, but also after sale and transfer of the vehicles to a consumer, in order to allow the functionality (computer vision, for example) to be continuously improved via updates the fleet may include, for example, more than 1e1, more than 1e2, more than 1e3, more than 1e4, more than 1e5, more than 1e6, or more than 1e7 vehicles.

Such data volumes generally have a high level of redundancy. On the one hand, this data volume predominantly describes normal operating/driving scenarios which are often already known. In contrast, for example corner cases, which are important for the design and improvement of the vehicle, may be unlikely, in particular for higher-dimensional parameter spaces. On the other hand, each time recording, taken alone or in combination with other time recordings, may contain redundant information (for example, data points in constant phases, or proportionalities between signals such as vehicle speed and rotational frequency of a drive machine in certain operating/driving states).

By use of trace graphs in accordance with the present invention, the one or multiple operating/driving scenarios may be stored in an aggregated manner, and thus (largely) free of redundancy (encoding step). By reconstruction via a simulation, for example, from these trace graphs it is then possible to once again generate operating/driving scenarios (decoding step) that essentially match the original operating/driving scenarios. In this sense, the trace graphs may be regarded as a reversible compression. The memory requirements of operating/driving scenarios may thus be reduced.

Such trace graphs may also be visualized (in a two-dimensional plane) by nodes and edges, for example, thus allowing development and testing engineers an additional perspective on operating/driving scenarios beyond time recordings. The nodes may be represented, for example, in different sizes and/or different colors (according to a heatmap, for example). It is thus possible to graphically, and thus clearly, represent frequency and/or dwell time, for example.

In addition, trace graphs may be advantageous when operating/driving scenarios are to be compared. Often, a new operating/driving scenario is to be compared to operating/driving scenarios that are already present, which, however, requires appropriate computing power due to the large data volume. In contrast, an increase in efficiency may be achieved when, instead of the operating/driving scenarios, their associated trace graphs are compared.

The term “vehicle” encompasses any device that transports passengers and/or cargo. A vehicle may be a motor vehicle (a passenger car or a truck, for example), or also a rail vehicle. However, floating and flying devices may also be vehicles.

Accordingly, the term “at least semi-autonomously operating vehicle” encompasses any device that transports passengers and/or cargo in an at least semi-autonomous manner. An at least semi-autonomously operating vehicle may be a motor vehicle (a passenger car or a truck, for example), or also a rail vehicle. However, floating and flying devices may also be at least semi-autonomously operating vehicles. The attribute “at least semi-autonomous” means that the vehicle, at least in some situations and/or at least at some times, is controlled autonomously (i.e., without involvement of a user), and/or that certain systems of the vehicle (assistance systems, for example) autonomously assist a driver, at least temporarily (an emergency braking system or a lane-keeping assistant, for example). In particular, the present disclosure relates to assisted and/or at least semi-autonomous motor vehicles; therefore, in the following discussion, aspects of the disclosure are thus explained using examples of at least semi-autonomously operating motor vehicles, including assisted motor vehicles (for example, autonomous vehicles of SAE J3016 autonomy levels 1 through 5). However, the aspects in question are also transferable to other types of at least semi-autonomously operating vehicles (provided that they do not pertain to specific circumstances of at least semi-autonomously operating motor vehicles).

The term “user” encompasses any person who drives the vehicle, is transported by the vehicle, or supervises the vehicle's operation. A user may be a passenger of a vehicle (in particular a driver). However, a user may also be situated outside the vehicle, and may for example control and/or supervise this vehicle (for example, during a parking operation or from a remote center).

An “operating scenario” may be any scenario that occurs during operation of the vehicle. For example, an operating scenario may be a certain driving situation. An operating scenario may refer to a temporally limited period during operation of the at least semi-autonomously operating vehicle (for example, shorter than 10 minutes or shorter than 1 minute). An operating scenario is not limited to scenarios in which the vehicle is moving (i.e., traveling).

The term “driving scenario” is understood to mean an operating scenario that occurs while the vehicle is traveling.

The term “sensor data” encompasses all data that are detected for the vehicle during operation of the vehicle. The sensor data may be detected by sensors of the vehicle. Sensor data may also be detected outside the vehicle (and transmitted to the vehicle). For example, GPS data (or other position data) are sensor data. The term “sensor data” also encompasses steps in processing the data which are carried out by the particular sensors, as well as corresponding metadata. Further examples are provided below.

“Field data” encompass all data that arise in conjunction with the operation of a vehicle (or a plurality of vehicles) and that are used, for example, to design (for example, train) at least semi-autonomous vehicles. For example, field data may be used to generate appropriate operating scenarios in a simulation environment for training at least semi-autonomous vehicles (or the systems contained therein).

### BRIEF DESCRIPTION OF THE DRAWINGS

FIG. 1A shows a flowchart that schematically illustrates the method according to the first general aspect of the present invention (or a specific embodiment thereof).

FIG. 1B shows a flowchart that illustrates the method according to the second general aspect of the present invention (or a specific embodiment thereof).

FIG. 2 schematically shows a computer program, a computer-readable medium or signal, and a computer system.

FIG. 3 shows an example of a trace graph.

FIG. 4A shows one specific embodiment of a flowchart that schematically illustrates the method according to the first general aspect of the present invention.

FIG. 4B shows one specific embodiment of a flowchart that schematically illustrates the method according to the second general aspect of the present invention.

### DETAILED DESCRIPTION OF EXAMPLE EMBODIMENTS

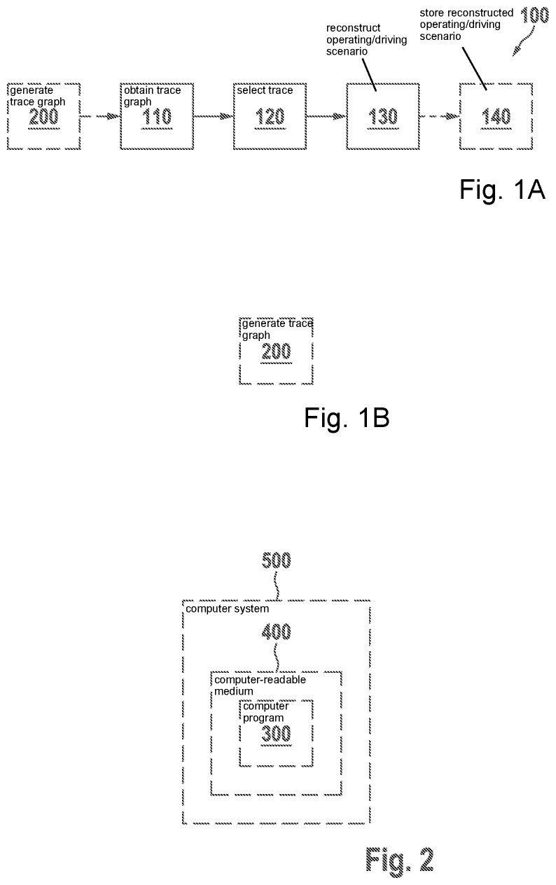

A computer-implemented method 100 for generating an operating/driving scenario based on a trace graph 10 is provided, which includes obtaining 110 trace graph 10, selecting 120 a trace 11 in trace graph 10, and reconstructing 130 an operating/driving scenario from trace 11 of trace graph 10. Method 100 is schematically illustrated in FIG. 1a, and in the sense of an autoencoder may be regarded as a decoder step. Trace graph 10 may be regarded as a compressed surrogate.

The operating/driving scenario may include one or multiple (for example, more than 2, more than 3, more than 4, more than 5, more than 10, more than 20, more than 50, more than 100, more than 200, more than 500, more than 1000) time recordings 20b, one or multiple time recordings 20b including at least one operating/driving state and/or at least one transition between two operating/driving states.

One or multiple time recordings 20b may be one or multiple sensor signals, optionally one or multiple sensor signals of a vehicle, in particular a vehicle that is at least assisted and/or travels semi-autonomously. The one or multiple time recordings may refer to the same time period. The sampling of the one or multiple sensor signals may be different.

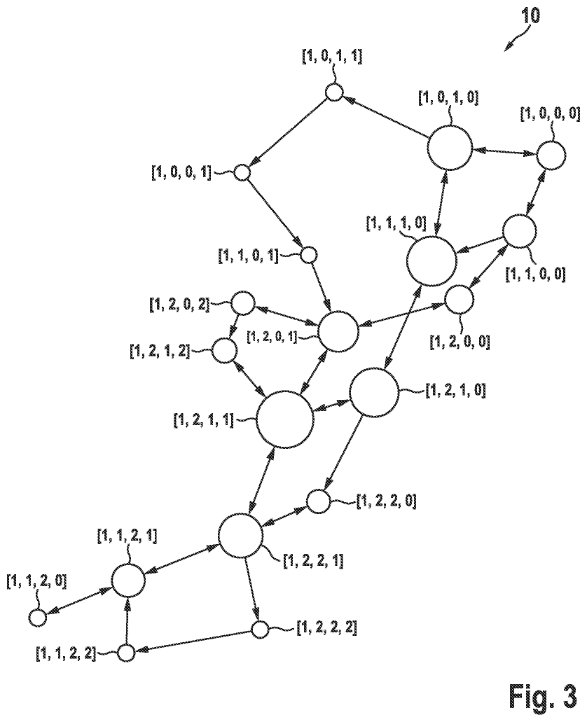

A trace graph 10, illustrated in FIG. 3, for example, may be a graph. The graph may include one or multiple nodes, each node corresponding to a value range in a space that is spanned by the (one-dimensional) value ranges of one or multiple time recordings 20a, 20b. The value ranges of every two nodes of trace graph 10 may be different. Overlappings between value ranges of every two nodes of trace graph 10 may be avoided. Each value range may be a higher-dimensional subset of the (vector) space that is spanned by the (one-dimensional) value ranges of one or multiple time recordings 20a, 20b. A node may correspond to a value range in the (vector) space, in that a vector, whose inputs are coordinates with regard to a base in the (vector) space and/or countings of subsets of the (vector) space, is associated with the node. For example, (higher-dimensional) intervals in the (vector) space may be consecutively numbered.

In certain cases, it may be advantageous for the trace graph to include more than one of at least one node. Such a node could represent, for example, an intermediate state that occurs in each of two operating/driving scenarios which, however, are to be kept separate.

The graph may also include no edge or one edge between every two nodes, each edge having at least one arrow direction, and optionally also possibly having opposite arrow directions, the arrow direction in each case indicating the direction of a transition between the value ranges associated with the nodes.

A frequency that is optionally represented by the size of the node may be associated with each node. Alternatively or additionally, a dwell time that may optionally be represented by color coding may be associated with each node. Alternatively or additionally, a transition frequency that may optionally be represented by further color coding may be associated with each edge, or with each edge and its direction (for example, in each case the arrowheads of edges may be correspondingly colored).

Trace 11 may be a sequence of two or more nodes of trace graph 10, in each case two successive nodes of the sequence having an arrow direction in the direction of the sequence. This sequence may also involve more than one of the one or multiple nodes of trace graph 10. In this case, a graphical representation of the trace then includes one or multiple closed loops.

The at least one trace graph 10 may be a data structure that represents one or multiple time recordings 20a, 20b in an aggregated and compressed form (i.e., largely free of redundancy). The one or multiple time recordings may in particular be sensor signals of the vehicle or of the vehicles of the vehicle fleet. The data structure may be stored in an XML or JSON format, for example. Metadata (for example, for unambiguously identifying vehicles in the vehicle fleet) may also be stored. By storing operating/driving scenarios, in particular simulated operating/driving scenarios, in trace graph 10, the data volume of individual stored operating/driving scenarios may be reduced in such a way that overall, a sufficiently large number of (simulated) operating/driving scenarios may be stored. Coverage of the actual and/or simulative tests, corresponding to the operating/driving scenarios, for the development process of the vehicle may be ensured in this way.

Obtaining 110 trace graph 10 may include loading trace graph 10 from a database. The selecting of trace graph 10 already implicitly involves a selection of one or multiple features, since each node in trace graph 10 corresponds to a particular value range in the same (vector) space that is spanned by the feature(s). For example, the y values of each time recording/time series/sensor signal may be classified into discrete classes (one-dimensional value ranges). Higher-dimensional value ranges may be formed from the one-dimensional value ranges via a direct product. In other words, each trace graph 10 may be associated with one or multiple features. FIG. 3 shows, for example, a trace graph 10 including four features, a four-dimensional vector ([1, 2, 1, 1], for example), whose inputs refer to the base in a vector space defined by the feature(s), being associated with each node.

An (arbitrary, for example) feature for characterizing an operating/driving state may include (or be) a time recording and/or a value range (or a portion of the value range, in particular a value) of the time recording. Alternatively or additionally, an (arbitrary, for example) feature may include (or be) a parameter of the one or multiple time recordings or a parameter derived therefrom. In the example case including four features, for example four-dimensional vector [1, 2, 1, 1] being associated with a node, for example the first input (here: a 1) of the vector may be associated with a value range of the vehicle speed from 20 km/h to 50 km/h. In addition, the second input (here: a 2) of the vector may, for example, be associated with a value range of the steering angle from 0° to +5°. Furthermore, for example the third input (here: a 1) of the vector may be an intensity of the backlight, derived from camera data, of 3 (or a value range, for example on a dimensionless scale from 1 to 5). In addition, for example the fourth input (here: a 1) of the vector may be a (discrete) classification result for detecting an obstacle on the roadway. Each possible other node of trace graph 10 may likewise include a four-dimensional vector ([2, 0, 1, 1, for example]), in each case including different inputs. The inputs of two vectors may be regarded as different when they differ at least in one input.

However, the vectors of the nodes of a trace graph may refer to the same features. For example, the first input (here: a 2) of the vector of the other node may likewise refer to the time recording of vehicle speed, and in particular to a value range of the vehicle speed, for example from 50 km/h to 70 km/h, etc.

Selecting 120 trace 11 may take place automatically and/or manually. An automatic selection may be achieved, for example, by selecting an arbitrary node as the starting node and from there, selecting a further arbitrary node in the arrow direction of an edge. This process may be repeated until a trace 11 of a desired length (number of nodes in a trace) is reached. However, depending on trace graph 20, it is also possible that the desired length of the trace cannot be reached. In this case, either a smaller length of the trace may be accepted, or a new attempt may be started with a different starting node. Alternatively or additionally, a manual selection may take place, for example during the selection of the starting node or when one of multiple possible edges is to be selected for the next node in the trace. A trace direction may result from the arrow directions of the edges between the nodes.

Reconstructing 130 the operating/driving scenario may take place in a simulation environment, optionally in CarMaker and/or in CARLA. The term “reconstructing” refers on the one hand to generating an operating/driving scenario based on a trace graph 10 that has originally been derived from a measurement.

Alternatively or additionally, “reconstructing” may be understood in the sense of “constructing,” i.e., independently of a derivation of trace graph 10 from a measurement. This may be the case, for example, when the trace graph itself has been synthetically generated or changed. Alternatively or additionally, the trace graph may originate from vehicle measurements of some other project (typically a predecessor project).

Reconstructing 130 the operating/driving scenario may be based on at least one parameter (standard or starting values, for example) from a parameter description model. The parameter description model may contain information (for example, further parameters, intervals, boundary conditions, etc.) that is necessary for reconstructing 130 the operating/driving scenario. For example, the vehicle mass and motorization, which are necessary for computing the dynamics (for example, acceleration to a higher vehicle speed), may be stored in the parameter description model.

Reconstructing 130 may also include parsing trace 11 and/or the parameter description model. During the parsing of trace 11, parameters of the transition may be extracted, starting from the first node of the sequence of trace 11 (via one edge each), to the particular next node of the sequence of trace 11. The information from the parameter description model may be used in the same way.

Reconstructing 130 may also include processing trace 11 and/or parameter description model. During the processing, for example configuration files or input files for the simulation environment may be generated. Furthermore, for each node of the sequence of trace 11, the processing of trace 11 and/or of the parameter description model may generate at least one element (for example, a transition, i.e., a portion of the operating/driving scenario) in the simulation environment.

Reconstructing 130 may also include interpolating between nodes of the sequence of trace 11.

Reconstructing 130 the operating/driving scenario may include generating at least one time recording for the operating/driving scenario. The nodes of the trace of the trace graph in the predefined direction may be processed. For example, for each node, states for the operating/driving scenario may be defined from the associated vector. Whereas the state of the first node of the trace represents an initial state of the operating/driving scenario, the target states for the transitions may be successively defined from the further nodes of the trace (and in the direction of the trace). Thus, for each edge of the trace, a transition between a state and the associated target state may be simulated. Each such transition may include at least one sub-time recording. The further parameters (dwell time, frequencies, transition probabilities, etc.) of the nodes and/or of the edges may optionally be taken into account in computing the transitions. The at least one sub-time recording computed for each edge of the trace may be concatenated to the at least one time recording of the operating/driving scenario to be generated. The further parameters may likewise be taken into account in this concatenation and/or when interpolating. For example, the concatenation of the at least one time recording for each edge of the trace may encompass a constant interpolation at the interfaces in order to take into account the dwell time associated with each node of the trace.

Method 100 may also include storing 140 the reconstructed operating/driving scenario in a file format.

Also provided is a computer-implemented method 200 for generating a trace graph 10 for one or multiple time recordings 20a. Method 200 includes clustering of y values of one or multiple time recordings 20a into at least two clusters in a (vector) space, whose dimensionality corresponds to the number of one or multiple time recordings (20a), optionally with the aid of unsupervised learning. Unsupervised machine learning may optionally be used (for example, k-means clustering or other clustering methods).

For example, the y values of two time recordings 20a (vehicle speed and steering angle, for example) may be mapped (as a point cloud) into a two-dimensional (vector) space, and two-dimensional clusters, i.e., two-dimensional subsets, may be defined in the two-dimensional (vector) space.

Alternatively, the generating of trace graph 10 for one or multiple time recordings 20a (or additionally, the clustering of y values of one or multiple time recordings 20a into at least two clusters in the (vector) space) may initially include separate clustering of y values of each of time recordings 20a into one-dimensional clusters in each case, it being possible for at least two one-dimensional clusters to be defined, at least for one time recording 20a. In the case of multiple time recordings 20a, the generating of the trace graph (or the clustering of y values of one or multiple time recordings 20a into at least two clusters in the (vector) space) may then include creating higher-dimensional clusters in a (vector) space, whose dimensionality corresponds to the number of multiple time recordings 20a, by combining one-dimensional clusters for each time recording 20a. For example, if the y values of time recording 20a (of the vehicle speed, for example) are clustered into two clusters and the y values of the time recording 20a (of the steering angle, for example) are clustered into three clusters, six higher-dimensional (here: two-dimensional) clusters may be defined in the (vector) space.

In addition, method 200 includes identifying at least one cluster as a node in trace graph 10. At least two clusters are generally identified as nodes, since otherwise the trace graph can contain no edge and thus, no transition between states. The creation of nodes in the trace graph may include a state-to-vector transformation with regard to the one or multiple features. Furthermore, method 200 includes analyzing the transitions between clusters, based on or multiple time recordings 20a. Moreover, method 200 includes identifying at least one transition as an edge between two nodes in trace graph 10.

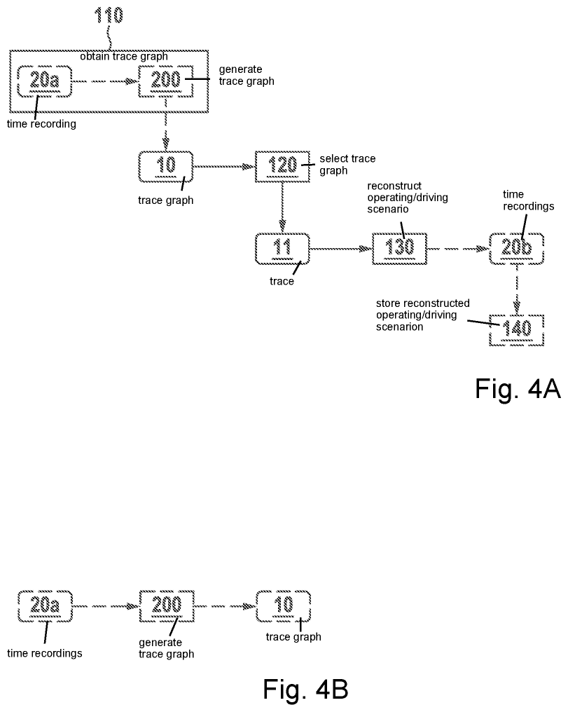

Method 200 is schematically illustrated in FIGS. 1b and 4b, and in the sense of an autoencoder may be regarded as an encoder step. An operating/driving scenario may be mapped into a trace graph 10 as a compressed surrogate.

Method 200 may also include evaluating the frequency of a cluster and/or the dwell time of a cluster based on one or multiple time recordings 20a. Alternatively or additionally, method 200 may include adding the frequency of a cluster and/or the dwell time of a cluster to the nodes in trace graph 10 that are identified by the cluster. The cluster formation may be designed in such a way that in the course of the cluster formation, irrelevant and/or redundant information in the one or multiple time recordings is eliminated.

Obtaining 110 trace graph 10 in method 100 may also include generating trace graph 10 for one or multiple time recordings 20a according to method 200 for generating trace graph 10. The combination of method 100 and method 200 is schematically illustrated in FIGS. 1a and 4a, and in the sense of an autoencoder may be regarded as a concatenation of an encoder step and a decoder step.

FIG. 4a shows one specific embodiment of method 100 for generating an operating/driving scenario based on a trace graph 10.

Also provided is a computer program 300 that is designed to carry out computer-implemented method 100 for generating an operating/driving scenario based on a trace graph 10, and/or to carry out computer-implemented method 200 for generating a trace graph 10 for one or multiple time recordings 20a. Computer program 300 may be present in an interpretable or compiled form, for example. For the execution, the computer program may be loaded, for example as a byte sequence, into the RAM of a control unit or computer.

Also provided is a computer-readable medium or signal 400 that stores and/or contains computer program 300. The medium may include, for example, one of RAM, ROM, EPROM, etc., in which the signal is stored.

Also provided is a computer system 500, schematically illustrated in FIG. 2, that is designed to execute computer program 300. Computer system 500 may in particular include at least one processor and at least one working memory. In addition, computer system 500 may include a memory with the database. Alternatively or additionally, computer system 500 may include a communication interface via which a link to the database may be established.

1-13. (canceled)

14. A computer-implemented method for generating an operating scenario of a vehicle based on a trace graph, the method comprising the following steps:
obtaining the trace graph;
selecting a trace in the trace graph; and
reconstructing an operating scenario of the vehicle from the trace of the trace graph.

15. The method as recited in claim 14, wherein the operating scenario includes one or multiple time recordings, the one or multiple time recordings including at least one operating state and/or at least one transition between two operating states.

16. The method as recited in claim 15, wherein the one or multiple time recordings are one or multiple sensor signals.

17. The method as recited in claim 16, wherein the one or multiple sensor signals are one or multiple sensor signals of an at least semi-autonomously traveling vehicle.

18. The method as recited in claim 15, wherein the trace graph is a graph including:
one or multiple nodes, each node of the nodes corresponding to a value range in a space that is spanned by value ranges of the one or multiple time recordings; and
no edge or one edge between every two nodes, each edge having at least one arrow direction, each arrow direction indicating a direction of a transition between the value ranges associated with the nodes.

19. The method as recited in claim 18, wherein the trace is a sequence of two or more nodes of the trace graph, in each case two successive nodes of the sequence having an arrow direction in a direction of the sequence.

20. The method as recited in claim 14, wherein the reconstructing of the operating scenario takes place in a simulation environment.

21. The method as recited in claim 20, wherein the simulation environment is in CarMaker and/or in CARLA.

22. The method as recited in claim 14, wherein the reconstructing of the operating scenario is based on at least one parameter from a parameter description model.

23. The method as recited in claim 22, wherein the reconstructing includes parsing the trace and/or the parameter description model.

24. A computer-implemented method for generating a trace graph for one or multiple time recordings of an operating scenario of a vehicle, the method comprising the following steps:
clustering y values of the one or multiple time recordings into at least two clusters in a space whose dimensionality corresponds to a number of the one or multiple time recordings;
identifying at least one cluster as a node in the trace graph;
analyzing transitions between clusters, based on the one or multiple time recordings; and
identifying at least one of the transitions as an edge between two nodes in the trace graph.

25. The method as recited in claim 24, wherein the clustering is performed using unsupervised learning.

26. The method as recited in claim 24, further comprising:
selecting a trace in the trace graph; and
reconstructing an operating scenario of the vehicle from the trace of the trace graph.

27. A non-transitory computer-readable medium on which is stored a computer program for generating an operating scenario of a vehicle based on a trace graph, the computer program, when executed by a computer, causing the computer to perform the following steps:
obtaining the trace graph;
selecting a trace in the trace graph; and
reconstructing an operating scenario of the vehicle from the trace of the trace graph.

28. A computer system configured to generate an operating scenario of a vehicle based on a trace graph, the computer system configured to:
obtain the trace graph;
select a trace in the trace graph; and
reconstruct an operating scenario of the vehicle from the trace of the trace graph.
